(19) United States
(12) Patent Application Publication
(10) Pub. No.: US 2026/0342772 A1
(43) Pub. Date: Oct. 29, 2026

(54) MACHINE LEARNING DATA MANAGEMENT SYSTEM

(71) Applicants: SHIBAURA INSTITUTE OF TECHNOLOGY, Tokyo (JP); GAIAX CO.LTD., Tokyo (JP)

(72) Inventors: Ryoichi SHINKUMA, Tokyo (JP); Aramu MINE, Tokyo (JP)

(73) Assignees: SHIBAURA INSTITUTE OF TECHNOLOGY, Tokyo (JP); GAIAX CO.LTD., Tokyo (JP)

(21) Appl. No.: 19/114,240

(22) PCT Filed: Dec. 21, 2023
(86) PCT No.: PCT/JP2023/045872

§ 371 Date: Mar. 21, 2025

(30) Foreign Application Priority Data
Jan. 5, 2023 (JP) 2023-000460

(51) Int. Cl. H04L 9/40; G06N 20/00

(52) U.S. Cl. CPC H04L 63/0428; G06N 20/00

(57) ABSTRACT

The present invention aims to provide a machine learning data management system capable of promoting the distribution of machine learning models between business operators. After receiving each piece of the machine learning data from the first information terminal 1 and encrypting each data into the first encrypted value, the first encrypted value is registered in the BC network 5. Further, when a portion of the machine learning data is provided from the first information terminal 1 to the second information terminal 2, the portion of the machine learning data is received from the second information terminal 2, the respective data is encrypted into the second encrypted value, and then the second encrypted value is compared with the first encrypted value of the machine learning data registered in the BC network 5 to determine the authenticity of the machine learning data.

### TECHNICAL FIELD

The present invention relates to a machine learning data management system for managing machine learning data including at least one of training data, a trained model, test data, or output data, the machine learning data being used in machine learning.

### BACKGROUND ART

In recent years, smart cities have gained attention as an approach to urban development aimed at addressing societal challenges by utilizing Information and Communication Technology (ICT) to improve quality of life and promote economic circulation through the creation of new value. This smart city serves as a platform that leverages Information and Communication Technology to efficiently provide essential urban infrastructure and public services, including administration, education, transportation, and public works.

Smart monitoring plays a crucial role in ensuring the safety of people in a smart city. In this smart monitoring, a machine learning (ML) model is used to detect objects, such as pedestrians and vehicles, from visual sensor data in the environment. Therefore, machine learning models need to be securely managed against malicious attacks such as tampering. However, research on the management of a machine learning model remains insufficient (e.g., see Non-Patent Documents 1 and 2).

Recently, machine learning models have been used in various fields, and for entities, including companies, universities, and public institutions, machine learning data, which includes training data, a trained model, test data, and output data used in machine learning, is recognized as one of the most important intellectual assets. The distribution of machine learning models among businesses is highly anticipated.

### PRIOR ART DOCUMENT

### Non-Patent Document

Non-Patent Document 1: Otoum et al., “Blockchain-supported federated learning for trustworthy vehicular networks,” in GLOBECOM 2020-2020 IEEE Global Communications Conference. IEEE, 2020, pp. 1-6.

Non-Patent Document 2: Korkmaz et al., “Chain FL: decentralized federated machine learning via blockchain,” in 2020 Second International Conference on Blockchain Computing and Applications (BCCA). IEEE, 2020, pp. 140-146.

### SUMMARY OF THE INVENTION

### Problems to Be Solved by the Invention

However, due to the insufficient research on the management methods of machine learning models, as mentioned above, they have been exposed to malicious attacks such as tampering, which has led to a lack of security. Additionally, if all (especially training data) of raw machine learning data, including training data, a trained model, test data, and output data, is provided from a data provider company to a data recipient company, there is a risk that the know-how and privacy contained in the machine learning data may be compromised.

On the other hand, if machine learning data in which all data is encrypted is provided from a data provider company to a data recipient company, it becomes difficult for the data recipient company to verify the authenticity of the machine learning model.

Therefore, although the distribution of machine learning models among businesses is expected in the future, there has been a problem that it is difficult to manage them while ensuring data confidentiality and security, thereby making it difficult to fully utilize machine learning models in various fields.

The present invention has been made in view of the above-mentioned problems, and its objectives are:
first, to manage machine learning data while ensuring its security;
second, to provide machine learning data from the data provider side to the data recipient side while maintaining a certain level of confidentiality; and
third, to enable the data recipient side to easily verify the authenticity of the machine learning data, thereby facilitating the distribution of machine learning models among businesses.

The present invention aims to provide a machine learning data management system capable of achieving these objectives.

### Means for Solving the Problem

In order to attain the above objects, the present invention provides a machine learning data management system comprising:
a first information terminal device on a data provider side;
a second information terminal device on a data recipient side; and
a server device,
wherein the first information terminal device, the second information terminal device, and the server device are communicably connected,
wherein the machine learning data management system is configured to manage machine learning data including training data, a trained model, test data, and output data, the machine learning data being used in a machine learning model,
wherein the server device comprises:
a first receiving unit configured to receive unencrypted machine learning data on the data provider side from the first information terminal device;
a first encryption unit configured to encrypt, into encrypted machine learning data, the unencrypted machine learning data on the data provider side that has been received by the first receiving unit;
a second receiving unit configured to receive, from the second information terminal device, unencrypted machine learning data that has been provided from the data provider side to the data recipient side;
a second encryption unit configured to encrypt, into encrypted machine learning data, the unencrypted machine learning data on the data recipient side that has been received by the second receiving unit;
a registration unit configured to register, in a blockchain network, the encrypted machine learning data on the data provider side that has been encrypted by the first encryption unit; and
a verification unit configured to determine authenticity of the machine learning data provided from the data provider side to the data recipient side by comparing the encrypted machine learning data on the data provider side that has been encrypted by the first encryption unit and registered in the blockchain network with corresponding encrypted machine learning data on the data recipient side that has been encrypted by the second encryption unit.

Further, the present invention provides a machine learning data management system comprising:
a first information terminal device on a data provider side;
a second information terminal device on a data recipient side; and
a server device,
wherein the first information terminal device, the second information terminal device, and the server device are communicably connected,
wherein the machine learning data management system is configured to manage machine learning data including training data, a trained model, test data, and output data, the machine learning data being used in a machine learning model, and
wherein the server device comprises:
a first receiving unit configured to receive, from the first information terminal device, at least one piece of data selected from the group consisting of training data, a trained model, test data, and output data of unencrypted machine learning data on the data provider side;
a first encryption unit configured to individually encrypt, into at least one first-encrypted value, the at least one piece of data selected from the group consisting of the training data, the trained model, the test data, and the output data of the machine learning data on the data provider side that has been received by the first receiving unit;
a second receiving unit configured to receive, from the second information terminal device, at least one piece of data selected from the group consisting of training data, a trained model, test data, and output data of unencrypted machine learning data that has been provided from the data provider side to the data recipient side, wherein the at least one piece of data is within a range of the machine learning data received by the first receiving unit;
a second encryption unit configured to individually encrypt, into at least one second-encrypted value, the at least one piece of data selected from the group consisting of the training data, the trained model, the test data, and the output data of the machine learning data on the data recipient side that has been received by the second receiving unit;
a registration unit configured to register, in a blockchain network, the at least one first-encrypted value of encrypted machine learning data on the data provider side that has been individually encrypted by the first encryption unit; and
a verification unit configured to determine authenticity of the machine learning data provided from the data provider side to the data recipient side by comparing the at least one first-encrypted values of the machine learning data on the data provider side that has been registered in the blockchain network with corresponding the at least one second-encrypted value of the machine learning data on the data recipient side.

Further, the present invention provides a machine learning data management system comprising:
a first information terminal device on a data provider side;
a second information terminal device on a data recipient side; and
a server device,
wherein the first information terminal device, the second information terminal device, and the server device are communicably connected,
wherein the machine learning data management system is configured to manage machine learning data including training data, a trained model, test data, and output data, the machine learning data being used in a machine learning model, and
wherein the server device comprises:
a first receiving unit configured to receive, from the first information terminal device, at least two pieces of data selected from the group consisting of training data, a trained model, test data, and output data of unencrypted machine learning data on the data provider side;
a first encryption unit configured to individually encrypt, into at least two first-encrypted values, the at least two pieces of data selected from the group consisting of the training data, the trained model, the test data, and the output data of the unencrypted machine learning data on the data provider side that has been received by the first receiving unit;
a second receiving unit configured to receive, from the second information terminal device, at least two pieces of data selected from the group consisting of training data, a trained model, test data, and output data of unencrypted machine learning data that has been provided from the data provider side to the data recipient side, wherein the at least two pieces of data are identical to the at least two pieces of data of the machine learning data received by the first receiving unit;
a second encryption unit configured to individually encrypt, into at least two second-encrypted values, the at least two pieces of data selected from the group consisting of training data, trained model, test data, and output data of unencrypted machine learning data on the data recipient side that has been received by the second receiving unit;
an integrating encryption unit configured to collectively encrypt, into a first integrated encrypted value, the at least two first-encrypted values of the machine learning data on the data provider side that has been individually encrypted by the first encryption unit, and collectively encrypt, into a second integrated encrypted value, the at least two second-encrypted values on the data recipient side that has been individually encrypted by the second encryption unit;
a registration unit configured to register, in a blockchain network, the first integrated encrypted value of the machine learning data on the data provider side that has been collectively encrypted by the integrating encryption unit; and
a verification unit configured to determine authenticity of the machine learning data provided from the data provider side to the data recipient side by comparing the first integrated encrypted value of the machine learning data on the data provider side that has been registered in the blockchain network with the second integrated encrypted value of the machine learning data on the data recipient side.

The present invention provides a machine learning data management system comprising:
a first information terminal device on a data provider side;
a second information terminal device on a data recipient side; and
a server device,
wherein the first information terminal device, the second information terminal device, and the server device are communicably connected,
wherein the machine learning data management system is configured to manage machine learning data including training data, a trained model, test data, and output data, the machine learning data being used in a machine learning model, and
wherein the server device comprises:
a first receiving unit configured to receive, from the first information terminal device, at least two pieces of data selected from the group consisting of training data, a trained model, test data, and output data of unencrypted machine learning data on the data provider side;
a first encryption unit configured to individually encrypt, into at least two first-encrypted values, the at least two pieces of data selected from the group consisting of the training data, the trained model, the test data, and the output data of the machine learning data on the data provider side that has been received by the first receiving unit;
a second receiving unit configured to receive, from the second information terminal device, at least one piece of data selected from the group consisting of training data, a trained model, test data, and output data of unencrypted machine learning data that has been provided from the data provider side to the data recipient side, wherein the at least one piece of data is a portion of data within a range of the machine learning data received by the first receiving unit, and at least one third-encrypted value of at least one other piece of data selected from the group consisting of training data, a trained model, test data, and output data of machine learning data that has been encrypted, wherein the at least one other piece of data is a remaining portion of data within a range of the machine learning data that has been received by the first receiving unit;
a second encryption unit configured to individually encrypt, into at least one second-encrypted value, the at least one piece of data selected from the group consisting of training data, trained model, test data, and output data of unencrypted machine learning data on the data recipient side that has been received by the second receiving unit;
an integrating encryption unit configured to collectively encrypt, into a first integrated encrypted value, the at least two first-encrypted values of the machine learning data on the data provider side that has been individually encrypted by the first encryption unit, and collectively encrypt, into a second integrated encrypted value, the at least one second-encrypted values of the machine learning data on the data recipient side that has been individually encrypted by the second encryption unit and the at least one third-encrypted value of the machine learning data on the data recipient side that has been received by the second receiving unit;
a registration unit configured to register, in a blockchain network, the first integrated encrypted value of the machine learning data on the data provider side that has been collectively encrypted by the integrating encryption unit; and
a verification unit configured to determine authenticity of the machine learning data provided from the data provider side to the data recipient side by comparing the first integrated encrypted value of the machine learning data on the data provider side that has been registered in the blockchain network with the second integrated encrypted value of the machine learning data on the data recipient side that has been provided from the data provider side to the data recipient side.

### Effects of the Invention

According to the present invention, machine learning data used in machine learning models can be managed while ensuring the security of the machine learning models, by registering the machine learning data, which is used in machine learning models, in an encrypted state in a blockchain network.

Furthermore, when only a portion of the machine learning data, such as training data, a trained model, test data, and output data, is provided from the data provider side to the data recipient side, it becomes possible to provide a machine learning model from the data provider side to the data recipient side while maintaining the confidentiality of certain data.

Furthermore, by comparing the machine learning data provided from the data provider side to the data recipient side with the machine learning data that the data provider side has registered in the blockchain network, the data recipient side can easily verify the authenticity of the machine learning model.

Therefore, machine learning data used in machine learning models can be managed while ensuring security, confidentiality, and authenticity, thereby facilitating the distribution of machine learning models among businesses.

### BRIEF DESCRIPTION OF THE DRAWINGS

FIG. 1 is a schematic configuration diagram illustrating the machine learning data management system according to an embodiment of the present invention.

FIG. 2 is a block diagram illustrating the functions of the registration server and the user server of the machine learning data management system according to a first embodiment.

FIG. 3 is a block diagram illustrating the functions of the blockchain network of the machine learning data management system according to the first embodiment.

FIG. 4 is a flowchart illustrating the operation of the machine learning data management system according to the first embodiment.

FIG. 5 is a block diagram illustrating the functions of the registration server and the user server of the machine learning data management system according to a second embodiment.

FIG. 6 is a flowchart illustrating the operation of the machine learning data management system according to the second embodiment.

### EMBODIMENTS FOR CARRYING OUT THE INVENTION

### First Embodiment

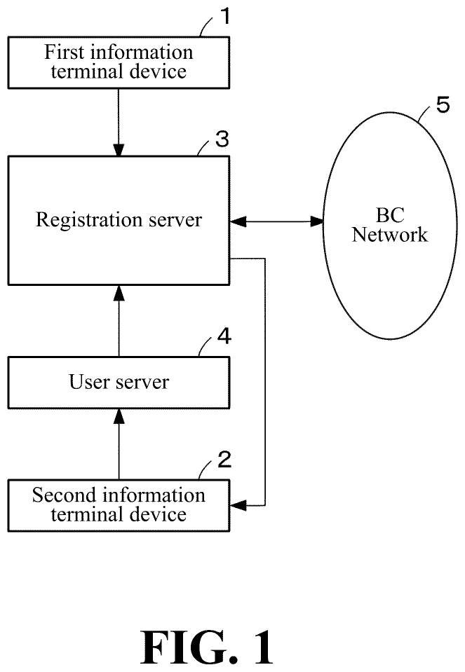

Next, an embodiment of the machine learning data management system (hereinafter, referred to as “this system”) according to the present invention will be described with reference to FIGS. 1 to 4.

As shown in FIG. 1, this system is provided with a first information terminal device 1 on a data provider side, a second information terminal device 2 on a data recipient side, a registration server 3 communicably connected to the first information terminal device 1, a user server 4 communicably connected to both the second information terminal device 2 and the registration server 3, and a blockchain network (hereinafter, referred to as “BC network 5”) connected to the registration server 3 via a network. This system manages machine learning data composed of training data, a trained model, test data, and output data, which are used in machine learning models. Note that the output data refers to the data output as a result of applying the test data to the trained model.

The first information terminal device 1 is an information terminal device of a data provider, such as a company owning machine learning data, and is configured from a device such as a PC (personal computer), a tablet terminal device, and a smartphone terminal device.

The second information terminal device 2 is an information terminal device of a data recipient such as a company that receives machine learning data from a data provider and is configured from a device such as a PC (personal computer), a tablet terminal device, and a smartphone terminal device.

Note that in this embodiment, it is assumed that three raw data sets, namely, a trained model, test data, and output data, of unencrypted machine learning data are provided from the data provider side to the data recipient side and that, for confidentiality reasons, training data is not provided. Moreover, when providing the machine learning data, the three raw data sets may be transmitted over a network from the first information terminal device 1 on the data provider side to the second information terminal device 2 on the data recipient side, or may be provided through a recording medium between the data provider and the data recipient.

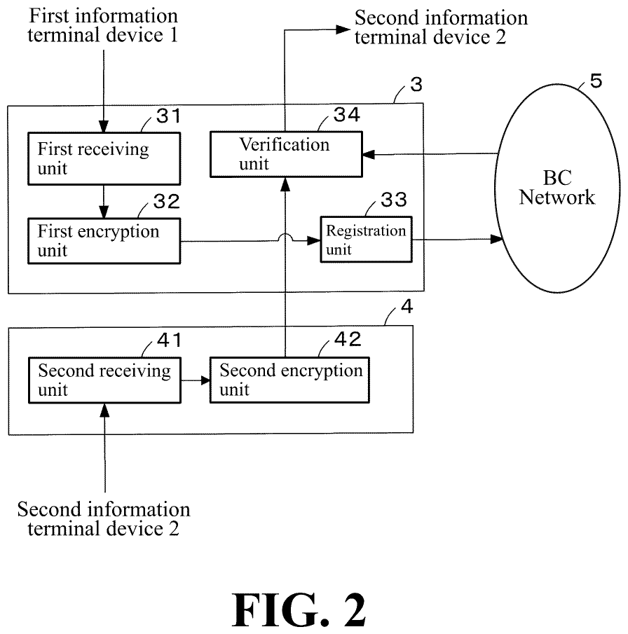

As shown in FIG. 2, the registration server 3 is provided with: a first receiving unit 31 that receives unencrypted machine learning data transmitted from the first information terminal device 1; a first encryption unit 32 that encrypts the machine learning data received by the first receiving unit 31, thereby generating encrypted machine learning data; a registration unit 33 that registers the encrypted machine learning data in the BC network 5; and a verification unit 34 that verifies the encrypted machine learning data.

The first receiving unit 31 is configured to receive four pieces of data, namely, training data, a trained model, test data, and output data, of the machine learning data transmitted from the first information terminal device 1. All of these four pieces of data are raw data sets that remain unencrypted when received from the first information terminal device 1.

The first encryption unit 32 encrypts the training data, the trained model, the test data, and the output data of the machine learning data into four respective first-encrypted values (hash values) by individually converting them using a predetermined hash function.

The registration unit 33 registers, in the BC network 5, the respective first-encrypted values of the training data, the trained model, the test data, and the output data of the machine learning data that has been encrypted by the first encryption unit 32. Note that the method of managing the first-encrypted values of the machine learning data by the BC network 5 will be described later.

The verification unit 34 is configured to compare the respective first-encrypted values of the machine learning data on the data provider side that has been registered in the BC network 5 with respective second-encrypted values of the machine learning data on the data recipient side, as will be described later. If the respective first-encrypted values and the respective second-encrypted values match, the machine learning data provided from the data provider side to the data recipient side is determined to be authentic. Conversely, if the respective first-encrypted values and the respective second-encrypted values do not match, the machine learning data provided from the data provider side to the data recipient side is determined to be non-authentic. Note that the result of the authenticity check of the machine learning data by the verification unit 34 is transmitted to the second information terminal device 2 on the data recipient side.

As shown in FIG. 2, the user server 4 is provided with: a second receiving unit 41 configured to receive machine learning data transmitted from the second information terminal device 2; and a second encryption unit 42 configured to encrypt the machine learning data received by the second receiving unit 41.

The second receiving unit 41 is configured to receive three pieces of data, namely, a trained model, test data, and output data, of the machine learning data transmitted from the second information terminal device 2. The three pieces of data, namely, the trained model, the test data, and the output data, of the machine learning data are provided from the data provider side to the data recipient side and are unencrypted raw data sets. Note that training data is not received as it is not provided from the data provider side to the data recipient side.

The second encryption unit 42 individually encrypts the three respective pieces of data, namely, the trained model, the test data, and the output data, of the machine learning data received by the second receiving unit 41, into three second-encrypted values (hash values) by individually converting them using a predetermined hash function. Note that the second-encrypted values are used, as described above, in the comparison of encrypted values by the verification unit 34.

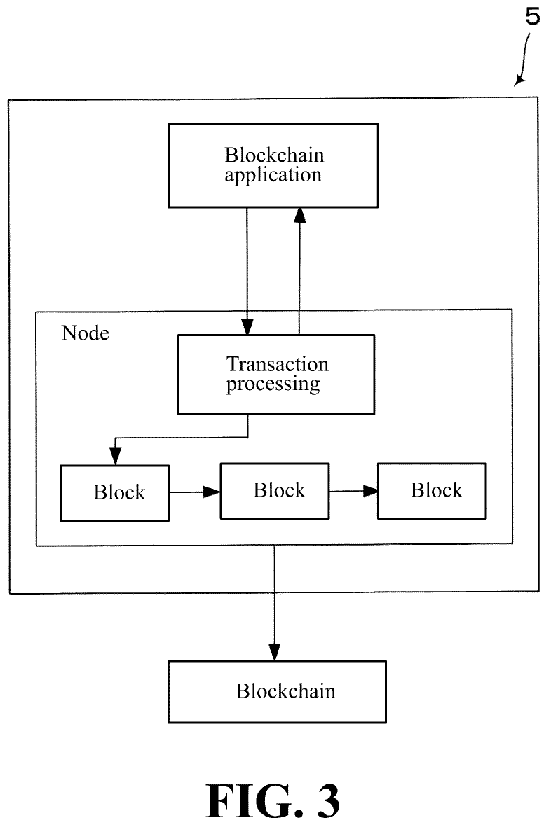

The BC network 5 is configured to manage data in a distributed manner by a plurality of terminal devices arranged on the network, and in recent years, it has gained attention as a technology for protecting confidential data, particularly from tampering. Specifically, the data managed by the BC network 5 has its entire history, including all registrations and changes, managed since the operation of the BC network 5 began, and anyone can view this history. The history of the data managed by the BC network 5 is consolidated into a single transaction, which is referred to as a block. Blocks are arranged in sequence, and a new block is added to the chain if it is valid. In general, a BC network system can be used from anywhere in the world as long as users are connected to the network, simply by installing software. By using the BC network 5, various benefits can be expected to address the issues of a centralized sensor network infrastructure, such as the ability to limit access rights to data, protection against unauthorized access through the use of one-way hash functions, and the ability to manage the entire history of data registration, changes, and other actions as block in the BC network. For example, as shown in FIG. 3, when an encrypted value (hash value) is received in a blockchain application, it is sent to a terminal device (node) for data verification through a transaction. Once the transaction is verified, the encrypted value (hash value) is written to the ledger as a block by the terminal device (node) and synchronized with the blockchain.

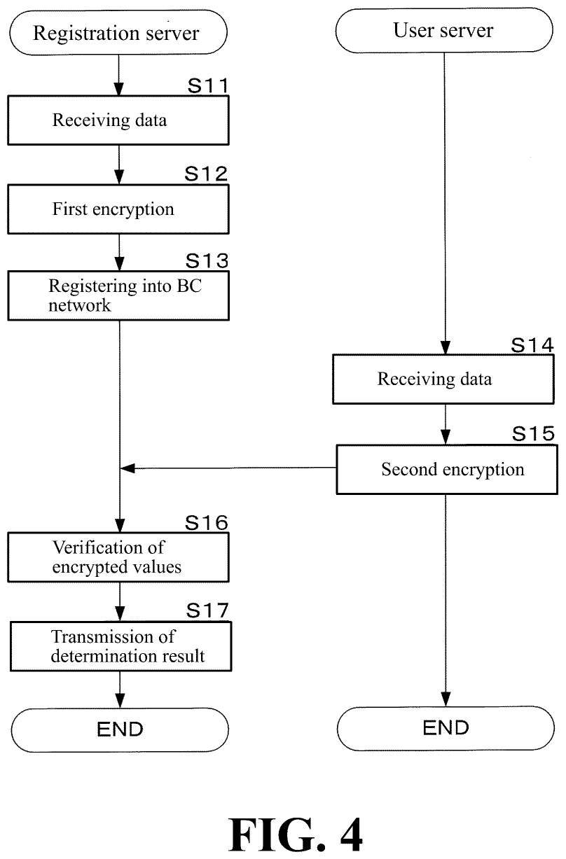

Next, the operation of this system will be described with reference to the flowchart shown in FIG. 4.

First, in the registration server 3, the first receiving unit 31 receives four pieces of data, namely, training data, a trained model, test data, and output data, of the machine learning data on the data provider side that has been transmitted from the first information terminal device 1 (S11).

Then, the first encryption unit 32 individually encrypts the four pieces of data, namely, the training data, the trained model, the test data, and the output data, of the machine learning data, into four respective first-encrypted values (hash values) by individually converting them using a predetermined hash function (S12).

Then, the registration unit 33 registers the respective first-encrypted values of the machine learning data, namely, the training data, the trained model, the test data, and the output data, encrypted by the first encryption unit 32, in the BC network 5 (S13).

On the other hand, in the user server 4, the second receiving unit 41 receives three pieces of data, namely, a trained model, test data, and output data, of the machine learning data transmitted from the second information terminal device 2 (S14). Note that the three pieces of data, namely, the trained model, the test data, and the output data, of the machine learning data are provided from the data provider side to the data recipient side through, for example, a network or a storage medium.

Then, the second encryption unit 42 individually encrypts the three respective pieces of data, namely, the trained model, the test data, and the output data, of the machine learning data received by the second receiving unit 41, into three respective second-encrypted values (hash values) by converting them using a predetermined hash function (S15).

Then, in the registration server 3, the verification unit 34 compares the respective first-encrypted values of the machine learning data on the data provider side that has been registered in the BC network 5 with the respective second-encrypted values of the machine learning data on the data recipient side. If the respective first-encrypted values and the respective second-encrypted values match, the machine learning data provided from the data provider side to the data recipient side is determined to be authentic. Conversely, if the respective first-encrypted values and the respective second-encrypted values do not match, the machine learning data provided from the data provider side to the data recipient side is determined to be non-authentic (S16).

Subsequently, the result of the authenticity determination of the machine learning data by the verification unit 34 is transmitted to the second information terminal device 2 on the data recipient side (S17).

It should be noted that, in the above embodiment, the server device is configured as two separate servers, namely, the registration server 3 and the user server 4. However, it may alternatively be configured as a single server.

Furthermore, the first encryption unit 32 and the second encryption unit 42 encrypt data by converting it into hash values (encrypted values) using a hash function. However, encryption is not limited to this method and may be performed using other encryption methods.

Furthermore, three pieces of data, namely, the trained model, the test data, and the output data, of the machine learning data is provided from the data provider side to the data recipient side. However, it may be configured such that one or two pieces of data of the machine learning data are provided, or all four pieces of data of the machine learning data are provided.

### Second Embodiment

Next, a second embodiment of the machine learning data management system according to the present invention will be described with reference to FIGS. 1, 5, and 6.

As shown in FIG. 1, similarly to the first embodiment, this system is provided with a first information terminal device 1 on the data provider side, a second information terminal device 2 on the data recipient side, a registration server 3 communicably connected to the first information terminal device 1, a user server 4 communicably connected to both the second information terminal device 2 and the registration server 3, and a BC network 5 connected to the registration server 3 via a network. This system is configured to manage machine learning data composed of training data, a trained model, test data, and output data, which is used in machine learning.

In this embodiment, it is assumed that three raw data sets, namely, a trained model, test data, and output data, of machine learning data are provided from the data provider side to the data recipient side with only the encrypted value of training data provided for confidentiality reasons.

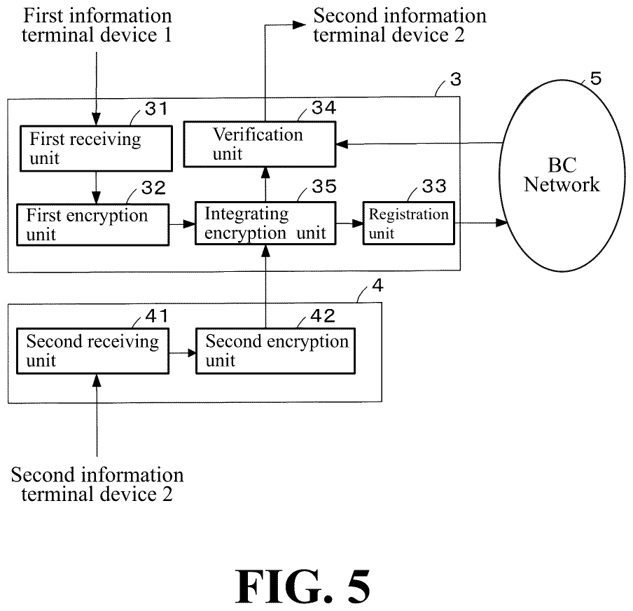

As shown in FIG. 5, the registration server 3 is provided with: a first receiving unit 31 configured to receive unencrypted machine learning data transmitted from the first information terminal device 1; a first encryption unit 32 configured to encrypt the machine learning data received by the first receiving unit 31; an integrating encryption unit 35 configured to collectively encrypt the machine learning data encrypted by the first encryption unit 32 and the second encryption unit 42, as described later; a registration unit 33 configured to register the encrypted machine learning data in the BC network 5; and a verification unit 34 configured to verify the encrypted machine learning data.

The first receiving unit 31 receives four pieces of data, namely, training data, a trained model, test data, and output data, of the machine learning data transmitted from the first information terminal device 1. These four pieces of data are raw data sets that have not yet been encrypted when received from the first information terminal device 1.

The first encryption unit 32 individually encrypts the four pieces of data, namely, the training data, the trained model, the test data, and the output data, of the machine learning data into four respective first-encrypted values (hash values) by individually converting them using a predetermined hash function.

The integrating encryption unit 35 collectively encrypts the four first-encrypted values of the training data, the trained model, the test data, and the output data of the machine learning data, which have been individually encrypted by the first encryption unit 32, into a single first integrated encrypted value (hash value) by converting them using a predetermined hash function.

The integrating encryption unit 35 collectively encrypts three second-encrypted values (hash values) of the trained model, the test data, and the output data of the machine learning data, which have been converted by the second encryption unit 42 of the user server 4 along with a single third-encrypted value (hash value) of training data, as described later, which has been received by the second receiving unit 41 of the user server 4, into a single second integrated encrypted value (hash value) by converting them using a predetermined hash function.

The registration unit 33 registers the first integrated encrypted value of the machine learning data, which has been encrypted by the integrating encryption unit 35, in the BC network 5. Since the method of managing the first integrated encrypted value of the machine learning data by the BC network 5 is the same as in the first embodiment, its description is provided.

The verification unit 34 compares the first integrated encrypted value of the machine learning data on the data provider side, which has been registered in the BC network 5, with the second integrated encrypted value of the machine learning data on the data recipient side. If the first integrated encrypted value and the second integrated encrypted value match, the machine learning data provided from the data provider side to the data recipient side is determined to be authentic. On the other hand, if the first integrated encrypted value and the second integrated encrypted value do not match, the machine learning data provided from the data provider side to the data recipient side is determined to be non-authentic. The authenticity determination of the machine learning data by the verification unit 34 is transmitted to the second information terminal device 2 on the data recipient side.

As shown in FIG. 5, the user server 4 is provided with: a second receiving unit 41 configured to receive the machine learning data transmitted from the second information terminal device 2; and a second encryption unit 42 configured to encrypt the machine learning data received by the second receiving unit 41.

The second receiving unit 41 receives three pieces of data, namely, a trained model, test data, and output data, of machine learning data transmitted from the second information terminal device 2 along with a single third-encrypted value of training data of the machine learning data, which has also been transmitted from the second information terminal device 2. Note that the three pieces of machine learning data, namely, the trained model, the test data, and the output data, are provided from the data provider side to the data recipient side and are raw data sets that have not yet been encrypted. Additionally, the third-encrypted value of the training data of the machine learning data is data that has been provided from the data provider side to the data recipient side along with other data, and, when received from the second information terminal device 2, it has already been encrypted by the first encryption unit 32 or another device.

The second encryption unit 42 encrypts the three pieces of raw data, namely, the trained model, the test data, and the output data, of the unencrypted machine learning data into three respective second-encrypted values (hash values) using a predetermined hash function.

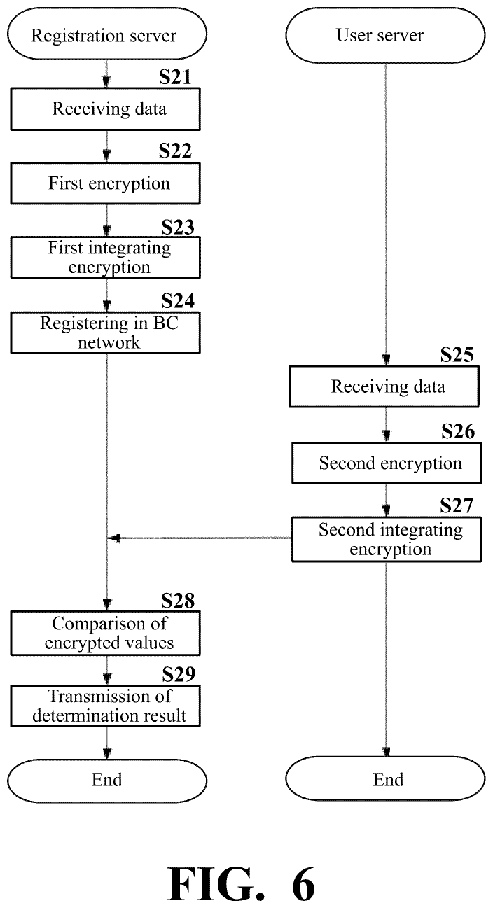

Next, the operation of this system will be described with reference to the flowchart shown in FIG. 6.

First, in the registration server 3, the first receiving unit 31 receives four pieces of data, namely, training data, a trained model, test data, and output data, of the machine learning data transmitted from the first information terminal device 1 on the data provider side (S21).

Then, the first encryption unit 32 individually encrypts the four pieces of data, namely, the training data, the trained model, the test data, and the output data, of the machine learning data into four respective first-encrypted values (hash values) by individually converting them using a predetermined hash function (S22).

Then, the integrating encryption unit 35 collectively encrypts the four first-encrypted values of the training data, the trained model, the test data, and the output data of the machine learning data, which have been individually encrypted by the first encryption unit 32, into a single first integrated encrypted value (hash value) by converting them using a predetermined hash function (S23).

Then, the registration unit 33 registers the first integrated encrypted value of the machine learning data, which has been encrypted by the integrating encryption unit 35, in the BC network 5 (S24).

On the other hand, in the user server 4, the second receiving unit 41 receives three pieces of data, namely, a trained model, test data, and output data, of the machine learning data transmitted from the second information terminal device 2 along with a single third-encrypted value of the training data of the machine learning data, which has also been transmitted from the second information terminal device 2 (S25). Note that the three pieces of the machine learning data, namely, the trained model, the test data, and the output data, and the third-encrypted value of the training data, are provided from the data provider side to the data recipient side via, for example, a network or a storage medium.

Then, the second encryption unit 42 individually encrypts the three pieces of data of the machine learning data, namely, the trained model, the test data, and the output data, which have been received by the second receiving unit 41, into three respective second-encrypted values (hash values) by converting them using a predetermined hash function (S26).

Then, the integrating encryption unit 35 collectively encrypts the three second-encrypted values (hash values) of the machine learning data, namely, the trained model, the test data, and the output data, which have been converted by the second encryption unit 42 of the user server 4, along with the single third-encrypted value (hash value) of the training data, which has been received by the second receiving unit 41 of the user server 4, into a single second integrated encrypted value (hash value) by converting them using a predetermined hash function (S27).

Then, in the registration server 3, the verification unit 34 compares the first integrated encrypted value of the machine learning data on the data provider side, which has been registered in the BC network 5, with the second integrated encrypted value of the machine learning data on the data recipient side. If the first integrated encrypted value and the second integrated encrypted value match, the machine learning data provided from the data provider side to the data recipient side is determined to be authentic. On the other hand, if the first integrated encrypted value and the second integrated encrypted value do not match, the machine learning data provided from the data provider side to the data recipient side is determined to be non-authentic (S28).

Thereafter, the result of the authenticity determination of the machine learning data by the verification unit 34 is transmitted to the second information terminal device 2 on the data recipient side (S29).

In the above embodiment, it is described that the third-encrypted value of the training data is provided from the data provider side to the data recipient side, but it may be configured such that encrypted values of other data are provided, or such that no encrypted values are provided.

Additionally, it is described that the respective second-encrypted values of the trained model, the test data, and the output data of the machine learning data are collectively encrypted by the integrating encryption unit 35 along with the third-encrypted value of the pre-encrypted training data. However, if raw training data is also provided, it may be configured such that the second encryption unit 42 encrypts the training data into a second-encrypted value, and then the integrating encryption unit 35 collectively encrypts all the second-encrypted values of the machine learning data into a single second integrated encrypted value.

Furthermore, the present invention is not limited to collectively encrypting all of the machine learning data with the integrating encryption unit 35. It may be configured such that the encrypted values of at least two or more pieces of the machine learning data are collectively encrypted. In this case, each piece of the machine learning data corresponding to the first integrated encrypted value and each piece of the machine learning data corresponding to the second integrated encrypted value are equal in number and identical.

While the embodiments of the present invention have been described with reference to the drawings, the present invention is not limited to the illustrated embodiments. Various modifications and variations can be made within the scope of the present invention or within the equivalent scope.

### EXAMPLES

Next, Examples 1 and 2 of the present system will be described with reference to a comparison with conventional examples.

### Assumption

It is assumed that Company A (data provider), which is a transport robot company, newly creates a machine learning model for detecting pedestrians from data of a visual sensor (camera or LIDAR) and then provides the machine learning model to Company B (data recipient), which is a bus company.

### Conventional Example

[1] Company A collects a large number of samples of visual sensor data that captures pedestrians and uses them as training data to create a machine learning model.

[2] By using the machine learning model created by Company A in a vehicle, if the onboard visual sensor detects a pedestrian, it is possible to detect the location of the pedestrian from the data.

[3] Company A started a business to lease the machine learning model to other companies.

[4] Company B, which is a bus company, decided to evaluate the use of Company A's machine learning model.

[5] Company A provides three pieces of data, namely, a trained model, test data, and output data (detection results) from the test data. At this time, to protect know-how and privacy, Company A does not provide the raw training data to Company B. The trained model is not interpretable by humans. Also, the test data and the output data do not contain any know-how or private information.

[6] Company B confirmed that pedestrians could be detected using the test data provided by Company A and entered into an agreement to use it.

[7] Company B started the operation of autonomous buses using the machine learning model.

[8] An accident occurred when Company B's bus was unable to detect a pedestrian from the data acquired by the visual sensor.

[9] To investigate the cause of the accident, Company B checks whether there was any issue with Company A's machine learning model.

[10] When verifying whether the machine learning model used at the time of the accident matched the one provided during the contract with Company A, the following issues arose.

### (Issues)

The large data size of the machine learning model, especially that of deep learning models for visual sensors like the one in this case, makes it time-consuming to prove that the data matches at the bit level.
Even if the data matches, it cannot be proven that it is the machine learning model provided at the time of the contract with Company A.

### Example 1

[1] Company A collects a large number of samples of visual sensor data that captures pedestrians, calculates a hash value (1) for the data as a single training data, and registers the hash value (1) in the BC network 5.

[2] Company A uses the samples from [1] as training data to create a machine learning model, calculates a hash value (2) for the trained model, and registers the hash value (2) in the BC network 5.

[3] By using the machine learning model created by Company A in a vehicle, if the onboard visual sensor detects a pedestrian, the location of the pedestrian can be detected from the data. Company A calculates hash values (3) and (4) of the test data that prove this and the output data, and registers each of these hash values (3) and (4) in the BC network 5.

[4] Company A starts a business where it lends out the machine learning model to other companies and receives a fee.

[5] Company B, which is a bus company, decides to consider using Company A's machine learning model.

[6] Company A provides three pieces of data, namely, a trained model, test data, and output data, from the test data. At this time, due to concerns about confidentiality of know-how and privacy, Company A does not provide the training data to Company B. Trained models are not understandable by humans. Also, the test data and the output data do not contain any know-how or privacy-related information.

[8] Company B confirms that pedestrians can be detected using the test data provided by Company A. Company B calculates each of the hash values (2′), (3′), and (4′) of the trained model, the test data, and the output data, verifies that these match the hash values (2), (3), and (4) in the BC network 5, and then signs a contract to use the model.

[9] Company B begins operating an autonomous bus using the machine learning model. Additionally, it registers each of the hash values (2′), (3′), and (4′) of the trained model, the test data, and the output data of the used machine learning model in the BC network 5.

[10] Company B's bus fails to detect a pedestrian from the data captured by the visual sensor, resulting in an accident.

[11] Company B uses this system to verify whether there was an issue with Company A's machine learning model regarding the cause of the accident.

[1] The system compares each of the hash values (2′), (3′), and (4′) of the trained model, the test data, and the output data of the used machine learning model at the time of the accident with the corresponding hash values (2), (3), and (4) of the machine learning model provided at the time of the contract with Company A. Since the hash values of the machine learning model data from both the data provider side and the data recipient side are registered in the BC network 5, they can be compared, proving that Company A's machine learning model was used. Moreover, because the hash values are much smaller in size than the raw machine learning data, they can be verified quickly.

### (Issues)

For each of the three pieces of data, i.e., the trained model, the test data, and the output data, it is necessary to perform verification with this system, which requires registration and management costs in the BC network 5, as well as time costs for verification.
The four pieces of data, namely, the training data, the trained model, the test data, and the output data, are registered independently in the BC network 5, without any connection between them.
Since Company B is not provided with any information regarding the training data, there is no way to prevent Company A from tampering with the training data after an accident occurs.

### Example 2

[1] Company A collects a large number of samples of visual sensor data that captures pedestrians and calculates a hash value (1) for them as a single learning data set. The hash value (1) is then used.

[2] Company A uses the sample from [1] as training data to create a machine learning model and calculates the hash value (2) of the trained model.

[3] By using the machine learning model created by Company A in a vehicle, if the onboard visual sensor detects a pedestrian, it is possible to detect the pedestrian's location from the data. Hash values (3) and (4) of the test data that prove this and its output data are calculated.

[4] In this system, the above four hash values (1) to (4) are integrated to calculate a single hash value (5), which is then registered in the BC network 5.

[5] Company A starts a business of leasing the machine learning model to other companies and earning royalties.

[6] Company B, which is a bus operator, begins to consider using Company A's machine learning model.

[7] Company A provides the three pieces of data, namely, a trained model, test data, and output data, and the hash value (1), as well as the hash value (5) of the entire machine learning data. At this time, for confidentiality and privacy reasons, the actual training data is not provided to Company B. The trained model cannot be understood by humans even if viewed. Also, the test data and the output data do not contain any proprietary or privacy risks.

[8] Company B confirms that pedestrians can be detected using the test data provided by Company A, calculates each of the hash values of the trained model, the test data, and the output data (2′) (3′), and (4′), and integrates them with the hash value (1) of the training data to obtain the hash value (5′).

[9] Company B confirms that the hash value (5′) obtained in [8] matches the single registered hash value (5) in the BC network 5 and enters into a contract to use the machine learning model.

[10] Company B begins operating autonomous buses using the machine learning model. Each of the hash values (2′) (3′) (4′) of the trained model, the test data, and the output data of the used machine learning model are registered in the BC network 5.

[11] The bus of Company B fails to detect a pedestrian from the data captured by the visual sensor, resulting in an accident.

[12] Regarding the cause of the accident, Company B uses the system to verify whether there was an issue with Company A's machine learning model.

[13] The system verifies whether the machine learning model used at the time of the accident matches the one provided at the time of the contract with Company A. Specifically, it integrates the hash value (1) of the training data provided by Company A, the three hash values (2′) (3′), and (4′) calculated from the trained model, the test data, and the output data, and calculates a single hash value (5′). This value is then compared with the registered hash value (5) in the BC network 5.

According to this, the verification of the system can be completed in a single verification step, thus reducing the time cost. Moreover, the linkage of the four pieces of the training data, the trained model, the test data, and the output data is ensured by the BC network 5. Since Company B has received the hash value (1) of the training data from Company A, it can verify the linkage of these four pieces of data, preventing Company A from tampering with the training data after the accident.

### DESCRIPTION OF SYMBOLS

1 . . . First information terminal device
2 . . . Second information terminal device
3 . . . Registration server
   31 . . . First receiving unit
   32 . . . First encryption unit
   33 . . . Registration unit
   34 . . . Verification unit
   35 . . . Integrating encryption unit
4 . . . User server
   41 . . . Second receiving unit
   42 . . . Second encryption unit
5 . . . BC network

1. A machine learning data management system comprising:
a first information terminal device on a data provider side;
a second information terminal device on a data recipient side; and
a server device,
wherein the first information terminal device, the second information terminal device, and the server device are communicably connected,
wherein the machine learning data management system is configured to manage machine learning data including training data, a trained model, test data, and output data, the machine learning data being used in a machine learning model,
wherein the server device comprises:
a first receiving unit configured to receive unencrypted machine learning data on the data provider side from the first information terminal device;
a first encryption unit configured to encrypt, into encrypted machine learning data, the unencrypted machine learning data on the data provider side that has been received by the first receiving unit;
a second receiving unit configured to receive, from the second information terminal device, unencrypted machine learning data that has been provided from the data provider side to the data recipient side;
a second encryption unit configured to encrypt, into encrypted machine learning data, the unencrypted machine learning data on the data recipient side that has been received by the second receiving unit;
a registration unit configured to register, in a blockchain network, the encrypted machine learning data on the data provider side that has been encrypted by the first encryption unit; and
a verification unit configured to determine authenticity of the machine learning data provided from the data provider side to the data recipient side by comparing the encrypted machine learning data on the data provider side that has been encrypted by the first encryption unit and registered in the blockchain network with corresponding encrypted machine learning data on the data recipient side that has been encrypted by the second encryption unit.

2. A machine learning data management system comprising:
a first information terminal device on a data provider side;
a second information terminal device on a data recipient side; and
a server device,
wherein the first information terminal device, the second information terminal device, and the server device are communicably connected,
wherein the machine learning data management system is configured to manage machine learning data including training data, a trained model, test data, and output data, the machine learning data being used in a machine learning model, and
wherein the server device comprises:
a first receiving unit configured to receive, from the first information terminal device, at least one piece of data selected from the group consisting of training data, a trained model, test data, and output data of unencrypted machine learning data on the data provider side;
a first encryption unit configured to individually encrypt, into at least one first-encrypted value, the at least one piece of data selected from the group consisting of the training data, the trained model, the test data, and the output data of the machine learning data on the data provider side that has been received by the first receiving unit;
a second receiving unit configured to receive, from the second information terminal device, at least one piece of data selected from the group consisting of training data, a trained model, test data, and output data of unencrypted machine learning data that has been provided from the data provider side to the data recipient side, wherein the at least one piece of data is within a range of the machine learning data received by the first receiving unit;
a second encryption unit configured to individually encrypt, into at least one second-encrypted value, the at least one piece of data selected from the group consisting of the training data, the trained model, the test data, and the output data of the machine learning data on the data recipient side that has been received by the second receiving unit;
a registration unit configured to register, in a blockchain network, the at least one first-encrypted value of encrypted machine learning data on the data provider side that has been individually encrypted by the first encryption unit; and
a verification unit configured to determine authenticity of the machine learning data provided from the data provider side to the data recipient side by comparing the at least one first-encrypted values of the machine learning data on the data provider side that has been registered in the blockchain network with corresponding the at least one second-encrypted value of the machine learning data on the data recipient side.

3. A machine learning data management system comprising:
a first information terminal device on a data provider side;
a second information terminal device on a data recipient side; and
a server device,
wherein the first information terminal device, the second information terminal device, and the server device are communicably connected,
wherein the machine learning data management system is configured to manage machine learning data including training data, a trained model, test data, and output data, the machine learning data being used in a machine learning model, and
wherein the server device comprises:
a first receiving unit configured to receive, from the first information terminal device, at least two pieces of data selected from the group consisting of training data, a trained model, test data, and output data of unencrypted machine learning data on the data provider side;
a first encryption unit configured to individually encrypt, into at least two first-encrypted values, the at least two pieces of data selected from the group consisting of the training data, the trained model, the test data, and the output data of the unencrypted machine learning data on the data provider side that has been received by the first receiving unit;
a second receiving unit configured to receive, from the second information terminal device, at least two pieces of data selected from the group consisting of training data, a trained model, test data, and output data of unencrypted machine learning data that has been provided from the data provider side to the data recipient side, wherein the at least two pieces of data are identical to the at least two pieces of data of the machine learning data received by the first receiving unit;
a second encryption unit configured to individually encrypt, into at least two second-encrypted values, the at least two pieces of data selected from the group consisting of training data, trained model, test data, and output data of unencrypted machine learning data on the data recipient side that has been received by the second receiving unit;
an integrating encryption unit configured to collectively encrypt, into a first integrated encrypted value, the at least two first-encrypted values of the machine learning data on the data provider side that has been individually encrypted by the first encryption unit, and collectively encrypt, into a second integrated encrypted value, the at least two second-encrypted values on the data recipient side that has been individually encrypted by the second encryption unit;
a registration unit configured to register, in a blockchain network, the first integrated encrypted value of the machine learning data on the data provider side that has been collectively encrypted by the integrating encryption unit; and
a verification unit configured to determine authenticity of the machine learning data provided from the data provider side to the data recipient side by comparing the first integrated encrypted value of the machine learning data on the data provider side that has been registered in the blockchain network with the second integrated encrypted value of the machine learning data on the data recipient side.

4. A machine learning data management system comprising:
a first information terminal device on a data provider side;
a second information terminal device on a data recipient side; and
a server device,
wherein the first information terminal device, the second information terminal device, and the server device are communicably connected,
wherein the machine learning data management system is configured to manage machine learning data including training data, a trained model, test data, and output data, the machine learning data being used in a machine learning model, and
wherein the server device comprises:
a first receiving unit configured to receive, from the first information terminal device, at least two pieces of data selected from the group consisting of training data, a trained model, test data, and output data of unencrypted machine learning data on the data provider side;
a first encryption unit configured to individually encrypt, into at least two first-encrypted values, the at least two pieces of data selected from the group consisting of the training data, the trained model, the test data, and the output data of the machine learning data on the data provider side that has been received by the first receiving unit;
a second receiving unit configured to receive, from the second information terminal device, at least one piece of data selected from the group consisting of training data, a trained model, test data, and output data of unencrypted machine learning data that has been provided from the data provider side to the data recipient side, wherein the at least one piece of data is a portion of data within a range of the machine learning data received by the first receiving unit, and at least one third-encrypted value of at least one other piece of data selected from the group consisting of training data, a trained model, test data, and output data of machine learning data that has been encrypted, wherein the at least one other piece of data is a remaining portion of data within a range of the machine learning data that has been received by the first receiving unit;
a second encryption unit configured to individually encrypt, into at least one second-encrypted value, the at least one piece of data selected from the group consisting of training data, trained model, test data, and output data of unencrypted machine learning data on the data recipient side that has been received by the second receiving unit;
an integrating encryption unit configured to collectively encrypt, into a first integrated encrypted value, the at least two first-encrypted values of the machine learning data on the data provider side that has been individually encrypted by the first encryption unit, and collectively encrypt, into a second integrated encrypted value, the at least one second-encrypted values of the machine learning data on the data recipient side that has been individually encrypted by the second encryption unit and the at least one third-encrypted value of the machine learning data on the data recipient side that has been received by the second receiving unit;
a registration unit configured to register, in a blockchain network, the first integrated encrypted value of the machine learning data on the data provider side that has been collectively encrypted by the integrating encryption unit; and
a verification unit configured to determine authenticity of the machine learning data provided from the data provider side to the data recipient side by comparing the first integrated encrypted value of the machine learning data on the data provider side that has been registered in the blockchain network with the second integrated encrypted value of the machine learning data on the data recipient side that has been provided from the data provider side to the data recipient side.
